(19) United States
(12) Patent Application Publication
(10) Pub. No.: US 2012/0122326 A1
(43) Pub. Date: May 17, 2012

(54) Pluggable Varistor

(76) Inventor: Werner Kallee, Bad Friedrichshall (DE)

(21) Appl. No.: 13/319,863

(22) PCT Filed: May 7, 2010
(86) PCT No.: PCT/EP2010/056260

§ 371 Date: Jan. 24, 2012

(30) Foreign Application Priority Data
May 12, 2009 (DE) 10 2009 021 732.0

(51) Int. Cl. H01R 12/51

(52) U.S. Cl. 439/76.1

(57) ABSTRACT

In order to releasably mount an electronic or electric component, the component is combined in a subassembly along with a support element and a housing. An insulating member that is penetrated by through-holes is mounted on the external face of the support element. Connecting elements are accommodated within said through-holes. The connecting elements are electrically and mechanically connected to the support element on one side and project from the front of the insulating member on the other side, where the connecting elements are designed as contact elements that are to be inserted into plated-through bores of a printed circuit board. This allows the electronic component to be plugged as a subassembly to the housing containing the printed circuit board and be removed again as required. If necessary, multiple components can be arranged on the support element inside the housing if said components form a functional unit.

The invention is concerned with the connection of electrical or electronic components to printed circuit boards.

Printed circuit boards usually contain a large number of electronic components which are connected to one another with the aid of conductor tracks within the printed circuit board and on the printed circuit board. These components are normally soldered to the printed circuit board. However, there also exist electrical or electronic components which are intended to be functionally connected to printed circuit boards but which cannot or should not be connected to printed circuit boards in the conventional manner on account of their size and/or the need to be able to be replaced. It should therefore be possible for said components to be connected to the printed circuit board retrospectively as individual elements. However, retrospective soldering by hand is very time-consuming and is therefore out of the question.

It has already been proposed to electrically connect a separate electronic component, which has a plurality of electrical connections, to conductor tracks of the printed circuit board with the aid of insulation displacement contacts. At the same time, the component in question is fixed in a housing, which contains the printed circuit board, by means of elastic bearing elements (DE 202006016320 U1).

The invention is based on the object of providing a possible way of being able to mount an electronic or electrical component on a printed circuit board such that it can be replaced and with a low level of outlay, with the intention being for an electrical connection to be established at the same time as mounting is performed.

In order to achieve this object, the invention proposes an assembly having the features cited in claim 1. Developments of the invention are the subject matter of dependent claims.

Therefore, according to the invention, the electrical or electronic component which is to be retrospectively detachably mounted is mounted on a support element. The electronic component can be secured on this support element, for example in a non-replaceable manner, by soldering for example. However, it is also possible for the connections of the electronic component to be inserted into holes in the support element, for example into so-called Holtite contacts. This support element is connected to the printed circuit board with the aid of the integral conductive connecting elements by the contact elements being inserted into plated-through openings in the printed circuit board. The clamping force which is applied by the contact elements creates a mechanical and an electrical connection with conductor tracks of the printed circuit board. For replacement purposes, the support element is simply withdrawn from the printed circuit board together with the conductive connecting elements and the electronic component.

In a development of the invention, an insulating body may be provided, the connecting elements being accommodated in said insulating body and the contact elements projecting out of said insulating body. The insulating body therefore serves to hold the connecting elements, this being of particular importance when there are more than two connecting elements. This can occur when there is more than one electronic component, or one electronic component with more than two connections, on the support element.

At the same time, the insulating body forms a bearing surface for bearing against the printed circuit board.

In particular, provision can be made for the electrically conductive connecting elements to be arranged in passages in the insulating body which extend between the two end faces of the insulating body. As a result, the connecting elements are insulated toward the outside.

In a further development of the invention, provision can be made for the assembly to have a housing in which the support element and the electronic component itself are accommodated. This housing serves firstly to protect the electronic component and secondly as a possible way of grasping the assembly.

The insulating body can also be arranged in the housing.

In a further development of the invention, provision can be made for the support element to be accommodated in the housing in an interlocking manner. The support element can have, for example, the shape of a plate which is inserted into grooves in the inner wall of the housing.

The housing therefore combines the parts which are intended to be mounted on the printed circuit board in a replaceable manner, so as to form an article which can be handled in a standard manner.

The type of connection between the connecting elements and the support element itself, which does not need to be detachable, can be formed in accordance with requirements. For example, it is possible for a connecting element to be pressed into plated-through holes in the support element.

Another possible way of providing a connection at this point can involve the connecting element being indicated on the support element, for example using surface mounted technology (SMT).

If the connecting elements are held or secured in the insulating body such that they cannot be displaced in their insertion direction, the connection between the connecting elements and the support element can also serve, at the same time, to secure the support element to the insulating body and vice versa.

It goes without saying that another possible way of connecting the insulating body to the support element in another way is, for example, by means of additional elements or else by adhesive bonding.

If it is desired to also fasten the fastening elements to the support element in a detachable manner, provision can be made, according to the invention, for the connecting elements to also be in the form of contact elements at their end which is associated with the support element, that is to say secured in plated-through holes in the support element by clamping force. In this case, provision can be made for the clamping force at this point to be greater than on the opposite side, so that when the assembly is withdrawn, the insulating body together with the connecting elements is also withdrawn from the printed circuit board.

In a further development of the invention, provision can be made for the assembly to have at least one encoding pin which protrudes in the direction of the printed circuit board, for example by the same amount as the contact tongues of the contact elements. These encoding pins are designed to interact with corresponding openings in the printed circuit board in order to thus prevent incorrect insertion of the assembly.

The manner in which the contact elements are formed in order to allow securing by clamping can depend on the requirements of the individual case. For example, the contact elements can have two or more contact tongues which are separated from one another by a slot. This slot can be open or else closed at the end of the contact elements. The clamping force of the contact tongues can be adjusted to the desired value by the length of the slot. It goes without saying that other possible ways of adjusting the clamping force are also known.

According to the invention, for production purposes, provision can be made for the connecting elements to be stamped out of sheet metal. The insulating body can be produced from simple plastic by plastic injection molding. The support element can be a piece of printed circuit board material which contains plated-through holes or other attachment options for the electronic component which is to be accommodated.

The housing can also be designed to accommodate more than one component, for example if the plurality of components are functionally associated. The housing can also contain additional holders, so that the component contained in it is held not only by means of its connection wires to the support element but, for example, also by projections on the inside of the housing.

Further features, details and advantages of the invention can be found in the claims and the abstract, the wording of both of which is included in the description by way of reference, in the following description of preferred embodiments of the invention and with reference to the drawing, in which:

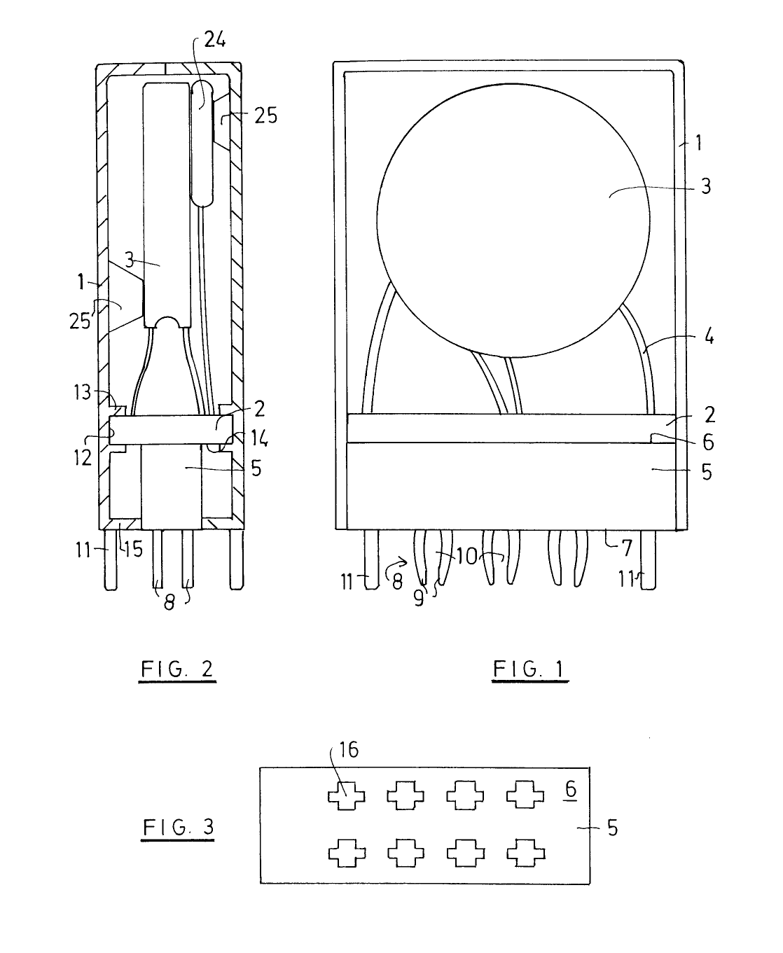

FIG. 1 shows a schematic cross section through an assembly according to the invention;

FIG. 2 shows a schematic cross section from another direction;

FIG. 3 shows a simplified plan view of an insulating body; and

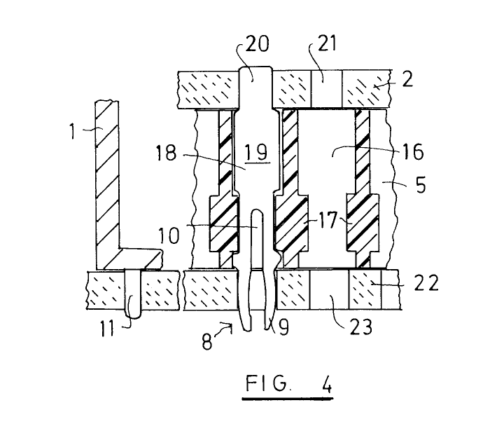

FIG. 4 shows a partial section through the insulating body between the support element and a printed circuit board.

The assembly illustrated in a simplified cross section in FIG. 1 contains a housing 1 which has an approximately cuboidal shape. This housing 1 is open on its lower face which is illustrated at the bottom in FIG. 1. A support element 2 which extends between the inner faces of the walls of the housing 1 is arranged in the housing. In the illustrated example, a varistor 3 together with its connections 4 is mounted on that side of the support element 2 which is directed inward. The connections 4 are, for example, soldered to conductor tracks of the support element 2 or inserted into plated-through holes in the support element 2. The varistor 3 is accommodated such that it is protected by the housing 1. In the illustrated example, the varistor 3 includes a thermal fuse 24 with the aid of which the temperature of the varistor 3 is intended to be monitored. This thermal fuse is arranged behind the varistor 3 in the simplified illustration in FIG. 1.

An insulating body 5, which likewise has an approximately cuboidal shape, is arranged directly on the outwardly directed lower face of the support element 2. Said insulating body has a lower end face 7 parallel to its upper end face 6 which bears against the support element 2, said lower end face, together with the edges of the housing 1, forming a termination for this assembly.

The support element 2 is in the form of a plate, in particular a small piece of a printed circuit board.

In the illustrated example, three contact elements 8 which each have two contact tongues 9 project from the lower end face 7 of the insulating body 5. A longitudinal slot 10 is formed between in each case two contact tongues 9 of a contact element 8. Two pins 11 which are of approximately the same length as the contact elements 8 likewise project from the lower face of the housing 1. These pins 11 serve as encoding pins.

The cross section in FIG. 2 shows that the support element 2, which is in the form of a plate, engages at its two longitudinal sides into in each case one groove 12 in the housing 1. The groove 12 is formed by two ribs 13 which run parallel to one another being formed on the inner face of the housing wall. As a result, the support element 2 is connected to the housing 1 in an interlocking manner in a direction which runs perpendicular to the direction of the contact elements 8. The housing 1 is composed of two part-shells. As a result, it is possible for the support element 2 to be inserted into the grooves 12.

Projections 25 are formed, in particular integrally formed, on the inner face of the two parts of the housing 1. These projections serve to push the thermal fuse 24 and the varistor 3 against one another, so that the thermal fuse can reliably monitor the temperature of the varistor 3.

The insulating body 5 which bears against the outwardly directed lower face 14 of the support element 2 is narrower than the support element 2. The housing 1 is provided on its lower face with inwardly directed flanges 15 which extend as far as the side walls of the insulating body 5.

The abovementioned encoding pins 11 are arranged further toward the outside than the contact elements 8.

FIG. 3 shows a simplified plan view of the insulating body 5 from an end face 6 thereof. The insulating body 5 has a large number of passages 16 which are arranged in two rows of in each case five passages 16 in the illustrated example. The cross-sectional shape of the passages 16 is cruciform.

FIG. 4 shows, on a slightly enlarged scale, a partial section through the insulating body 5. The insulating body 5 contains, as mentioned, passages 16 which run between the two end faces of the insulating body 5. The passages 15 have two inwardly directed projections 17, so that the cross section of the passage 17 is constricted at this point.

A connecting element 18 is inserted into each of the passages 16, FIG. 4 showing only one such connecting element 18. The connecting element 18 is produced from a piece of sheet metal by being stamped out and has a middle portion 19 which is in the form of a plate with two parallel side edges. At the point at which the inwardly directed projections 17 reduce the size of the cross section of the passage 16, the connecting element 18 has a constricted portion which is the same length as the two projections 17. As a result, the connecting element 18 is firmly held in the passage 16 in a non-displaceable manner.

On its side which faces the support element 2, the connecting element has a contact pin 20 which is pressed into a plated-through hole 21 in the support element 2. Axially securing the connecting element 18 in the insulating body 5 and pressing the contact pin into the plated-through hole 21 connects not only the connecting element 18, but also the insulating body 5, to the support element 2.

On the opposite side, which is at the bottom in FIG. 1 and FIG. 2, the connecting element has a contact element 8 which contains two contact tongues 9. The slot 10 which extends far into the interior of the insulating body 5 is formed between the two contact tongues 9. The clamping force with which the two contact tongues 9 are loaded in the outward direction when they are inserted into an opening can be adjusted by the length of the slot 10 and the material of the connecting elements 18.

FIG. 4 shows, at the bottom, the printed circuit board 22 to which the assembly is intended to be connected. This printed circuit board 22 has plated-through holes 23 into which the contact elements 8 at the end of the connecting elements 18 are inserted. On account of the curved outer face of the contact tongues 9, said contact tongues can be pushed into the holes 23 and, in the process, are moved toward one another. This creates a reaction force which leads to clamping of the connecting elements 18 in the holes 23 in the printed circuit board 22.

It is also possible to design the contact elements 8 in other ways.

If desired, a design in which the contact elements are not pressed in, but rather inserted so that they can then also be removed again, can also be selected for the opposite side for connection of the connecting elements 18 to the support element 2.

FIG. 4 likewise shows, see the left-hand part of FIG. 4, that the printed circuit board 22 also has holes in which the encoding pins 11 can engage, said encoding pins being arranged or formed on the lower face of the housing.

1. An assembly for detachable electrical and mechanical connection to a printed circuit board (22), containing:
1.1 a support element (2),
1.2 on which an electrical or electronic component (3) is electrically and mechanically mounted,
1.3 at least two integral conductive connecting elements (18) which
1.4 are electrically and mechanically connected in the region of one of their ends to conductor tracks of the support element (2), and
1.5 have a contact element (8) in the region of their respectively other end, said contact element
1.6 being designed for insertion into a plated-through hole (23) in the printed circuit board (22),
1.7 in which plated-through hole said contact element can be secured transverse to the insertion direction by clamping.

2. The assembly as claimed in claim 1, wherein the connecting elements (18) are arranged in an insulating body (5) which has two end faces (6, 7) which are averted from one another, one end face (6) of said insulating body resting against the support element (2) and the contact elements (8) projecting from the other end face (7) of said insulating body.

3. The assembly as claimed in claim 2, wherein the connecting elements (18) are in each case arranged in a passage (16) which extends between the two end faces (6, 7) of the insulating body (5).

4. The assembly as claimed in claim 1, having a housing (1) in which the electrical or electronic component (3) and the support element (2) and also the insulating body (5) are arranged.

5. The assembly as claimed in claim 4, wherein the support element (2) is secured in the housing (1) in an interlocking manner.

6. The assembly as claimed in claim 4, wherein the housing is of multipartite design and, in particular, consists of two half-shells.

7. The assembly as claimed in claim 1, wherein at least one connecting element (18) is pressed into plated-through holes (21) in the support element (2).

8. The assembly as claimed in claim 1, wherein at least one connecting element (18) is soldered to the support element (2).

9. The assembly as claimed in claim 2, wherein the insulating body (5) is mechanically fastened to the support element (2) with the aid of the connecting elements (18).

10. The assembly as claimed in claim 2, wherein the connecting elements (18) are inserted into plated-through holes (21) in the support element (2) and are secured there by clamping, with the clamping force being greater than in the case of the contact element (8) which is intended for connection to the printed circuit board (22).

11. The assembly as claimed in claim 1, having at least one encoding pin (11) which is preferably arranged on the housing (1) and interacts with a hole in the printed circuit board (22).

12. The assembly as claimed in claim 1, wherein at least one contact element (8) has at least two contact tongues (9) which are separated by a slot (10) which runs in the axial direction.

13. The assembly as claimed in claim 12, wherein the length of the slot (10) in the contact element (8) is greater than the portion of the contact tongues (9) which projects out of the insulating body (5).

14. The assembly as claimed in claim 1, wherein the connecting elements (18) are stamped out of sheet metal.

15. The assembly as claimed in claim 4, wherein the housing imparts loading and has holders for the electronic components which are contained in it.
